(19) United States
(12) Patent Application Publication
(10) Pub. No.: US 2025/0050522 A1
(43) Pub. Date: Feb. 13, 2025

(54) SHAVING RAZOR

(71) Applicant: The Gillette Company LLC, Boston, MA (US)

(72) Inventor: Donald William Loughlin, Natick, MA (US)

(21) Appl. No.: 18/366,359

(22) Filed: Aug. 7, 2023

(51) Int. Cl. B26B 21/40; B26B 21/18

(52) U.S. Cl. CPC B26B 21/4012; B26B 21/18

(57) ABSTRACT

A shaving razor. The shaving razor includes a blade platform configured to support one or more shaving blades and a housing cover removably secured on top of the blade platform. The housing cover has a front portion with a first textured surface including a first pattern of elements with a depth of 10 μm to 100 μm and a width of 20 μm to 100 μm at a top surface of the housing cover.

### FIELD OF THE INVENTION

The present invention relates to shaving razors and more particularly to shaving razors having textured surfaces on a front and/or rear portion to reduce and/or increase friction.

### BACKGROUND OF THE INVENTION

Some shaving razors available to consumers manage the friction of the shaving razor as it passes over the skin of the user during shaving with a combination of placing a low durometer elastomeric material at the leading edge of the blade platform, to increase friction and create skin stretch, and placing soap or a lubricating material at the trailing edge of the housing cover, to decrease friction and create the feeling of glide. However, these technologies for managing the friction of the shaving razor add the cost of additional components and incorporate the use of plastic-based material, which is not considered sustainable.

Therefore, a shaving razor is needed that controls the friction as the shaving razor passes over the skin without using additional components and, preferably, without using plastic-based materials.

### SUMMARY OF THE INVENTION

The present invention relates to a shaving razor.

In one implementation, the shaving razor can comprise a blade platform configured to support one or more shaving blades and a housing cover removably secured on top of the blade platform. The housing cover has a front portion with a first textured surface that includes a first pattern of elements with a depth of 10 μm to 100 μm and a width of 20 μm to 100 μm at a top surface of housing cover.

The first pattern of elements can comprise one of a first plurality of parallel grooves, a plurality of dimples, or the first plurality of parallel grooves and a second plurality of parallel grooves intersecting the first plurality of parallel grooves.

The first pattern of elements can comprise a first plurality of parallel grooves that extend longitudinally perpendicular to a front edge of the housing cover.

The blade platform can have a front portion with a second textured surface including a second pattern of elements with a depth of 10 μm to 100 μm and a width of 20 μm to 100 μm at a top surface of the blade platform.

The second pattern of elements can comprise one of a first plurality of parallel grooves, a plurality of dimples, or the first plurality of parallel grooves and a second plurality of parallel grooves intersecting the first plurality of parallel grooves.

The second pattern of elements can comprise a first plurality of parallel grooves that extend longitudinally either parallel or perpendicular to a front edge of the housing cover and a second plurality of parallel grooves intersecting the first plurality of parallel grooves and extending longitudinally at an angle of 45 to 75 degrees relative to the first plurality of parallel grooves.

The housing cover can have a rear portion with a third textured surface including a third pattern of elements with a depth of 10 μm to 100 μm and a width of 20 μm to 100 μm at a top surface of the housing cover.

The first pattern of elements and the third pattern of elements can comprise one of a first plurality of parallel grooves, a plurality of dimples, or the first plurality of parallel grooves and a second plurality of parallel grooves intersecting the first plurality of parallel grooves.

The third pattern of elements comprises a first plurality of parallel grooves that extend longitudinally perpendicular to a rear edge of the housing cover.

In another implementation, the shaving razor cartridge can comprise a blade platform configured to support one or more shaving blades and a housing cover removably secured on top of the blade platform. The blade platform can have a front portion with a second textured surface including a second pattern of elements with a depth of 10 μm to 100 μm and a width of 20 μm to 100 μm at a top surface of the blade platform.

The second pattern of elements can comprise one of a first plurality of parallel grooves, a plurality of dimples, or the first plurality of parallel grooves and a second plurality of parallel grooves intersecting the first plurality of parallel grooves.

The second pattern of elements can comprise a first plurality of parallel grooves that extend longitudinally either parallel to or perpendicular to a front edge of the housing cover and a second plurality of parallel grooves that intersect the first plurality of parallel grooves and extend longitudinally at an angle of 45 to 75 degrees relative to the first plurality of parallel grooves.

The first plurality of parallel grooves, the plurality of dimples, or the second plurality of parallel grooves can be spaced apart by a distance of 20 μm to 100 μm.

The blade platform can have a rear portion with a fourth textured surface including a fourth pattern of elements with a depth of 10 μm to 100 μm and a width of 20 μm to 100 μm at a top surface of the blade platform.

The second pattern of elements and the fourth pattern of elements can comprise one of a first plurality of parallel grooves, a plurality of dimples, or the first plurality of parallel grooves and a second plurality of parallel grooves intersecting the first plurality of parallel grooves.

The fourth pattern of elements can comprise a first plurality of parallel grooves that extend longitudinally either parallel to or perpendicular to a rear edge of the housing cover and a second plurality of parallel grooves that intersect the first plurality of parallel grooves and extend longitudinally at an angle of 45 to 75 degrees relative to the first plurality of parallel grooves.

The first plurality of parallel grooves, the plurality of dimples, or the second plurality of parallel grooves can be spaced apart by a distance of 20 μm to 100 μm.

The housing cover can have a front portion with a first textured surface including a first pattern of elements with a depth of 10 μm to 100 μm and a width of 20 μm to 100 μm at a top surface of the housing cover and a rear portion with a third textured surface including a third pattern of elements with a depth of 10 μm to 100 μm and a width of 20 μm to 100 μm at the top surface of the housing cover.

The first pattern of elements and the third pattern of elements can each comprise one of a first plurality of parallel grooves, a plurality of dimples, or the first plurality of parallel grooves and a second plurality of parallel grooves intersecting the first plurality of parallel grooves.

The first pattern of elements and the third pattern of elements can each comprise a first plurality of parallel grooves, wherein the first plurality of parallel grooves of the first pattern of elements extend longitudinally perpendicular to a front edge of the housing cover and the first plurality of grooves of the third pattern of elements extend longitudinally perpendicular to a rear edge of the housing cover.

### BRIEF DESCRIPTION OF THE DRAWINGS

While the specification concludes with claims particularly pointing out and distinctly claiming the subject matter that is regarded as forming the present invention, it is believed that the invention will be better understood from the following description, which is taken in conjunction with the accompanying drawings in which like designations are used to designate substantially identical elements, and in which:

FIG. 1 is a front perspective view of an example shaving razor;

FIG. 2 is an exploded view of the shaving razor of FIG. 1;

FIG. 3A is a front perspective view of a first example housing cover for use in the shaving razor of FIG. 1 with a first plurality of parallel grooves formed on a front portion and a rear portion;

FIG. 3B is an enlarged view of a portion of the housing cover of FIG. 3A;

FIG. 3C is a cross-sectional view of a portion of the housing cover of FIG. 3B taken along line 3C of FIG. 3B;

FIG. 4A is a front perspective view of a second example housing cover for use in the shaving razor of FIG. 1 with a first plurality of parallel grooves formed on a front portion and a rear portion;

FIG. 4B is an enlarged view of a portion of the housing cover of FIG. 4A;

FIG. 4C is a cross-sectional view of a portion of the housing cover of FIG. 4B taken along line 4C of FIG. 4B;

FIG. 5A is a front perspective view of a third example housing cover for use in the shaving razor of FIG. 1 with a plurality of dimples formed on a front portion and a rear portion;

FIG. 5B is an enlarged view of a portion of the housing cover of FIG. 5A;

FIG. 5C is a cross-sectional view of a portion of the housing cover of FIG. 5B taken along line 5C of FIG. 5B;

FIG. 6A is a front perspective view of a fourth example housing cover for use in the shaving razor of FIG. 1 with a first plurality of parallel grooves and a second plurality of parallel grooves formed on a front portion and a rear portion;

FIG. 6B is an enlarged view of a portion of the housing cover of FIG. 6A;

FIG. 6C is a cross-sectional view of a portion of the housing cover of FIG. 6B taken along line 6C of FIG. 6B;

FIG. 7A is a front perspective view of a fifth example housing cover for use in the shaving razor of FIG. 1 with a first plurality of parallel grooves and a second plurality of parallel grooves formed on a front portion and a rear portion;

FIG. 7B is an enlarged view of a portion of the housing cover of FIG. 7A;

FIG. 7C is a cross-sectional view of a portion of the housing cover of FIG. 7B taken along line 7C of FIG. 7B;

FIG. 8A is a front perspective view of a first example blade platform for use in the shaving razor of FIG. 1 with a first plurality of parallel grooves formed on a front portion and a rear portion;

FIG. 8B is an enlarged view of a portion of the blade platform of FIG. 8A;

FIG. 8C is a cross-sectional view of a portion of the blade platform of FIG. 8B taken along line 8C of FIG. 8B;

FIG. 9A is a front perspective view of a second example blade platform for use in the shaving razor of FIG. 1 with a first plurality of parallel grooves formed on a front portion and a rear portion;

FIG. 9B is an enlarged view of a portion of the blade platform of FIG. 9A;

FIG. 9C is a cross-sectional view of a portion of the blade platform of FIG. 9B taken along line 9C of FIG. 9B;

FIG. 10A is a front perspective view of a third example blade platform for use in the shaving razor of FIG. 1 with a plurality of dimples formed on a front portion and a rear portion;

FIG. 10B is an enlarged view of a portion of the blade platform of FIG. 10A;

FIG. 10C is a cross-sectional view of a portion of the blade platform of FIG. 10B taken along line 10C of FIG. 10B;

FIG. 11A is a front perspective view of a fourth example blade platform for use in the shaving razor of FIG. 1 with a first plurality of parallel grooves and a second plurality of parallel grooves formed on a front portion and a rear portion;

FIG. 11B is an enlarged view of a portion of the blade platform of FIG. 11A;

FIG. 11C is a cross-sectional view of a portion of the blade platform of FIG. 11B taken along line 11C of FIG. 11B;

FIG. 12A is a front perspective view of a fifth example blade platform for use in the shaving razor of FIG. 1 with a first plurality of parallel grooves and a second plurality of parallel grooves formed on a front portion and a rear portion;

FIG. 12B is an enlarged view of a portion of the blade platform of FIG. 12A;

FIG. 12C is a cross-sectional view of a portion of the blade platform of FIG. 12B taken along line 12C of FIG. 12B;

FIG. 13 is a flowchart illustrating a first example method for making a shaving razor; and

FIG. 14 is a flowchart illustrating a second example method for making a shaving razor.

### DETAILED DESCRIPTION OF THE INVENTION

The examples described herein relate to shaving razors. The example shaving razors herein can include micro-patterns etched into one or more surfaces by laser ablation/etching to make the surface(s) hydrophilic or hydrophobic and to increase or decrease the friction between the shaving razor and the skin of a user during shaving. The example shaving razors herein are preferably metal, to reduce the use of plastic-based materials, but could also be plastic, which would still reduce the number of components used in the shaving razor.

Various patterns could be etched into the front and/or rear portion of the blade platform and/or housing cover of the shaving razor to increase friction and create skin stretch or to decrease friction and create the feeling of glide, depending on the particular application. It is believed, without being held to theory, that some of the surface textures disclosed facilitate the trapping of water and shaving aid that a consumer may use for shaving on the surface of the shaving razor cartridge, as well as removing some of the higher friction metal material from the shaving surface, thus lowering surface friction and improving glide for a more comfortable shave. In addition, the surface textures may also be easily rinsed clean between shaves (e.g., surface texture does not trap shaving debris). It is believed, without being held to theory, that some of the surface textures disclosed may alternatively facilitate the gripping of the skin during a shaving stroke, thus improving skin stretch for a closer and more comfortable shave.

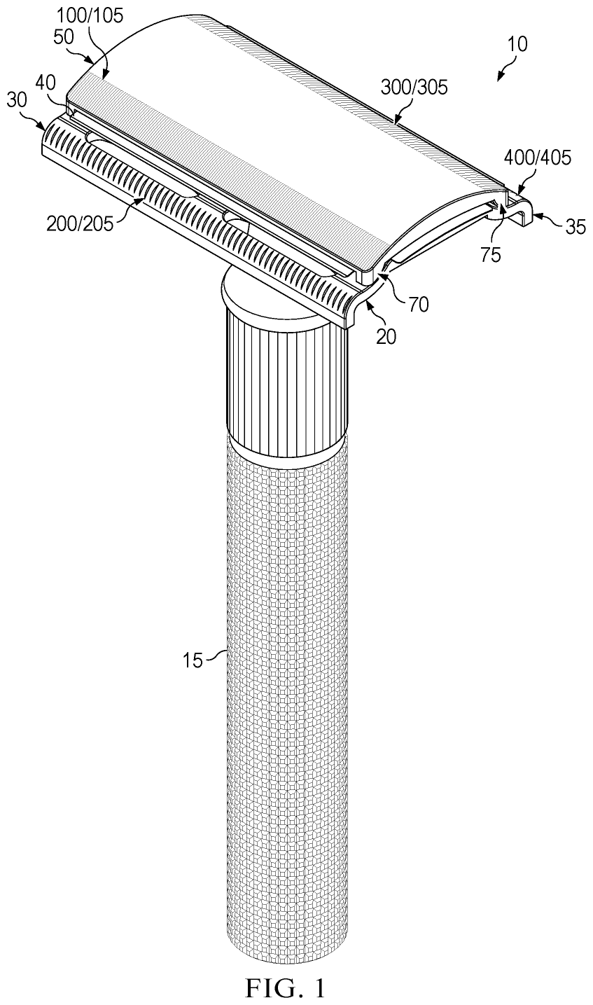

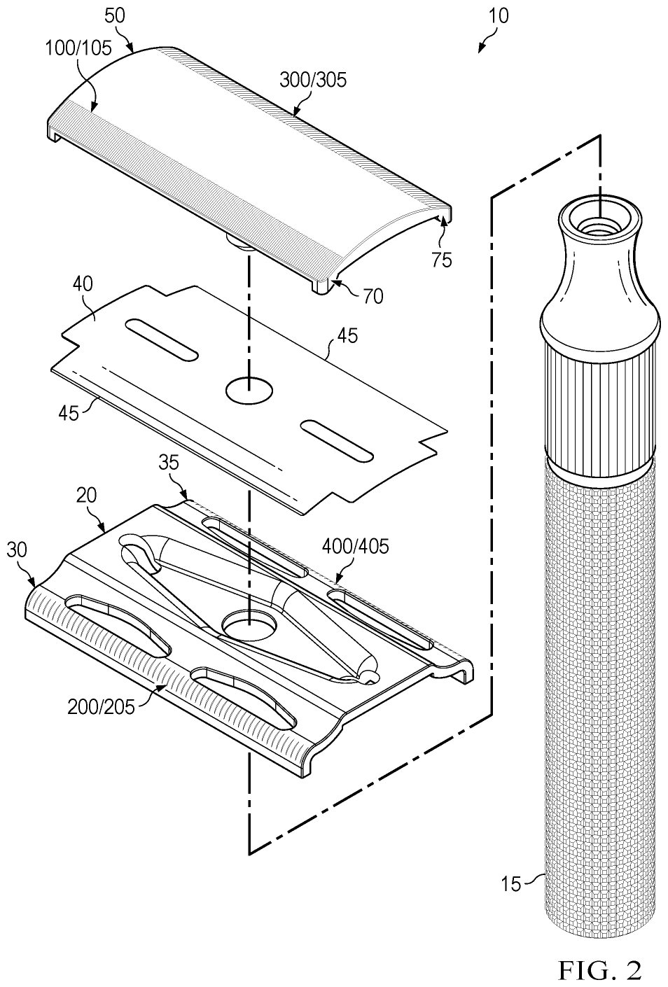

Referring to FIGS. 1-2, an example shaving razor 10 is shown, which generally includes a handle 15, a blade platform 20 configured to support one or more shaving blades 40, each having one or more cutting edge 45, and a housing cover 50. Blade platform 20 can be connected to, or removably connected to, handle 15 and housing cover 50 is removably secured on top of blade platform 20 to secure shaving blade 40 between blade platform 20 and housing cover 50, such that cutting edge 45 of shaving blade 40 is accessible between blade platform 20 and housing cover 50. As shown and described herein, shaving razor 10 is a double sided shaving razor and a first cutting edge 45A is accessible between a front portion 30 of blade platform 20 and a front portion 70 of housing cover 50 and a second cutting edge 45B is accessible between a rear portion 35 of blade platform 20 and a rear portion 75 of housing cover 50. Blade platform 20 and housing cover 50 are preferably a metal material, such as aluminum, anodized aluminum, stainless steel, titanium, etc. with a Brinell hardness of 30 to 100. A metal blade platform 20 and metal housing cover 50 may facilitate the formation of smaller and more precise features by laser ablation than is typically possible by injection molding plastic materials or machining or laser ablation of plastics.

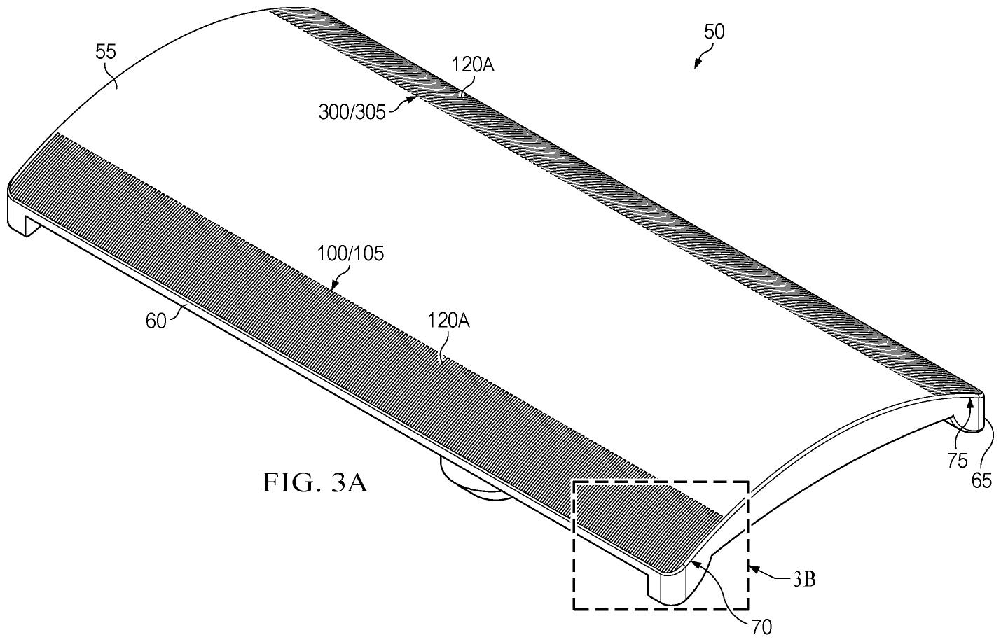

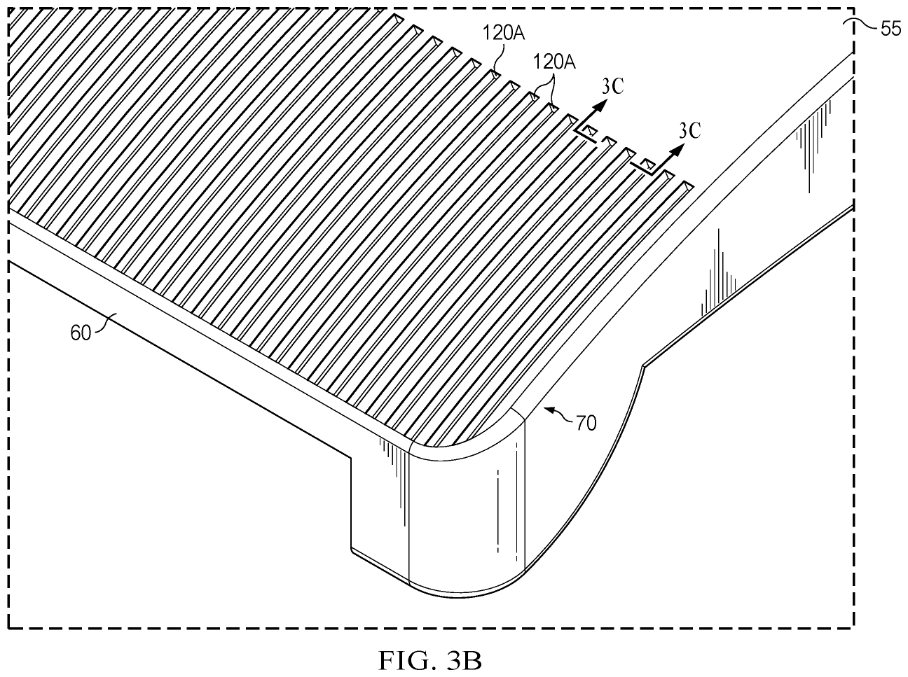

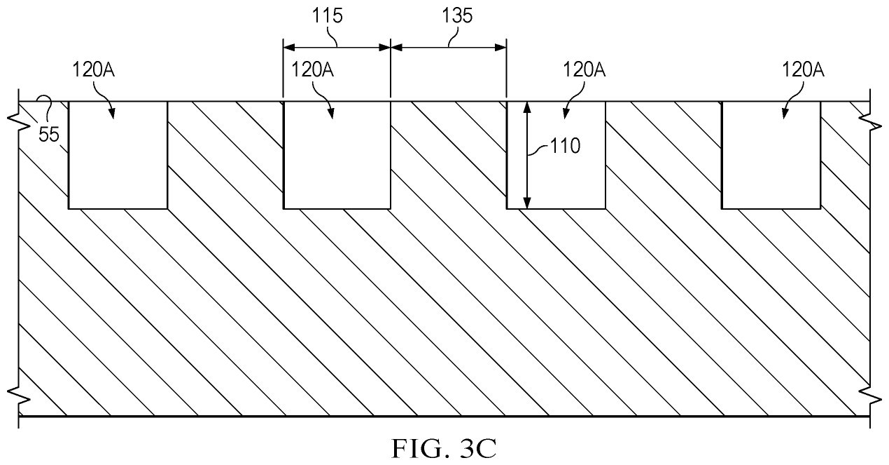

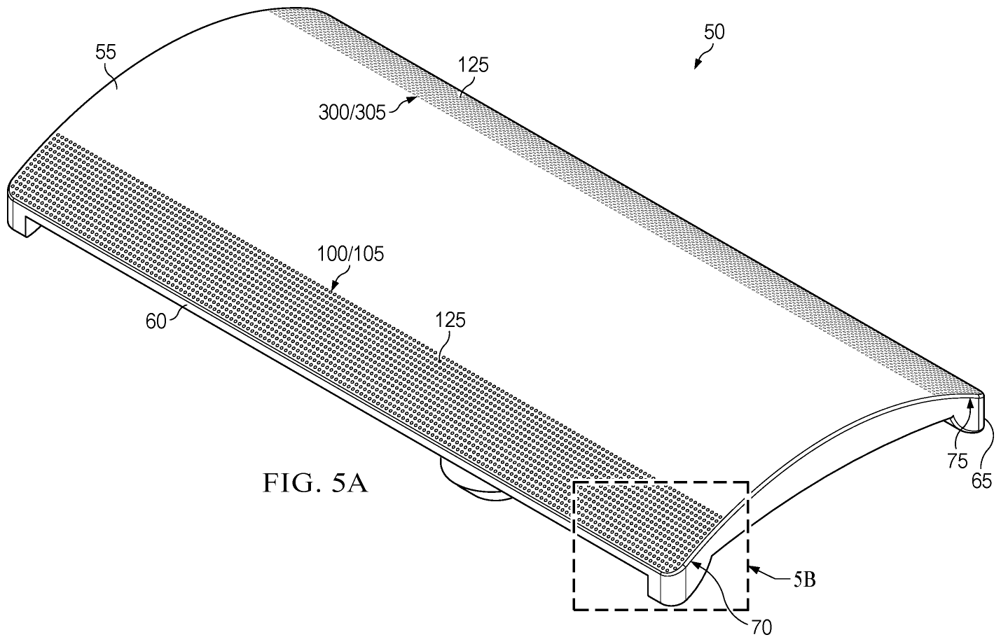

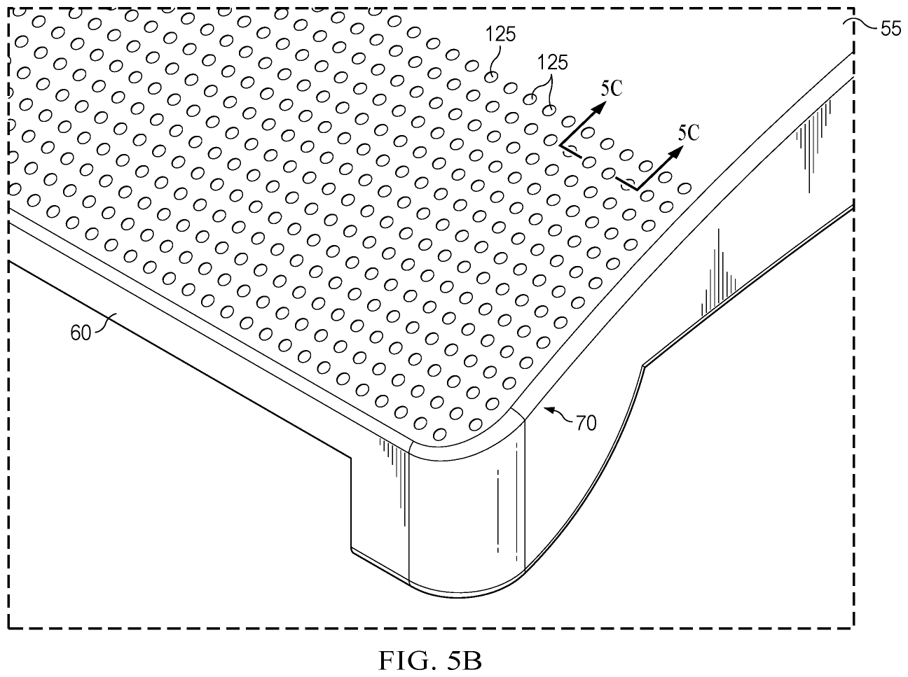

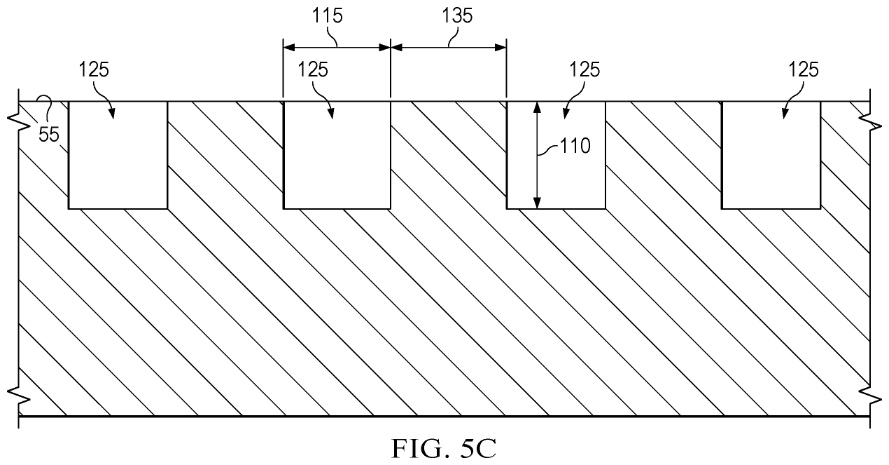

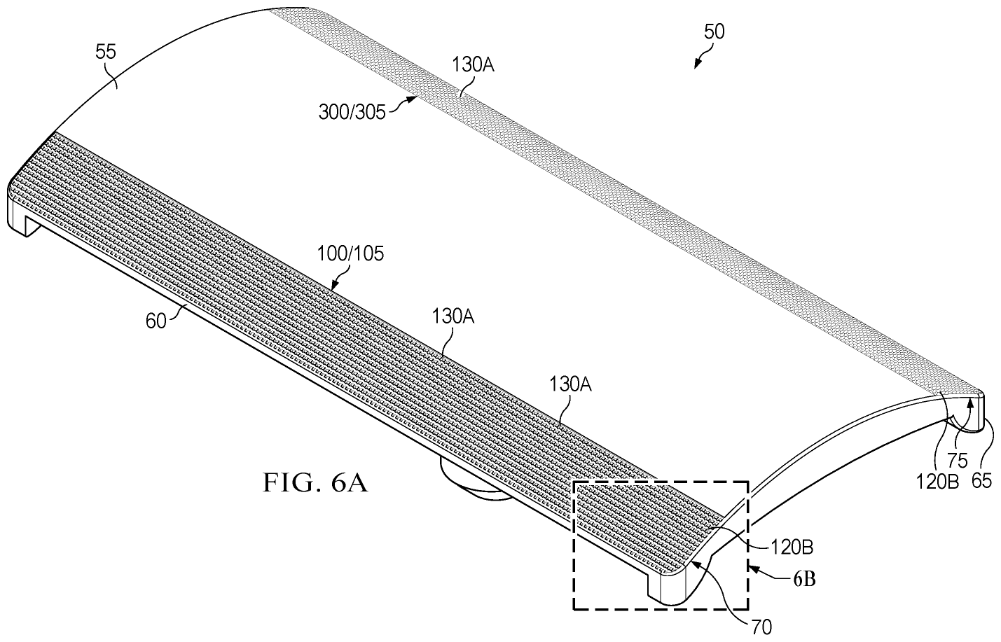

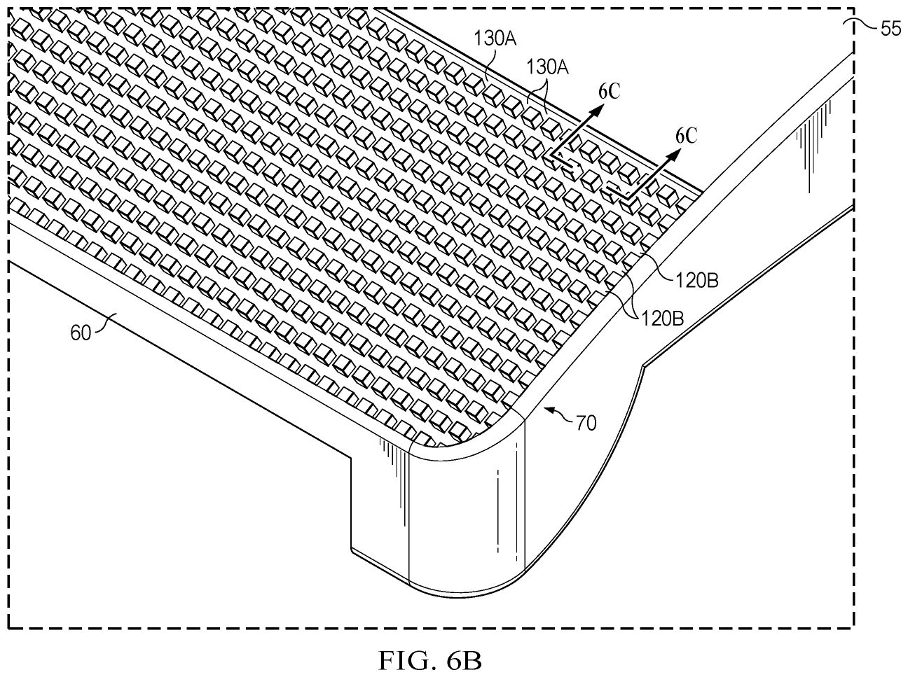

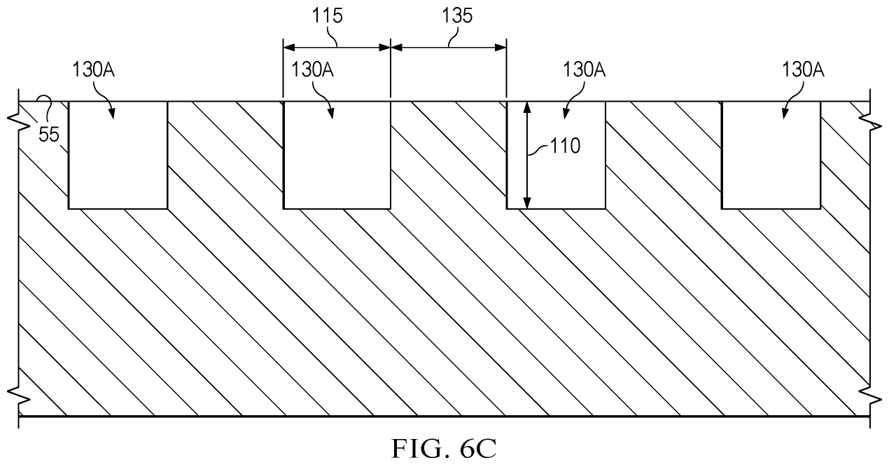

To manage the friction of shaving razor 10 as it passes over the skin of the user during shaving, front portion 70 of housing cover 50 could have a first textured surface 100 including a first pattern of elements 105, front portion 30 of blade platform 20 could have a second textured surface 200 including a second pattern of elements 205, rear portion 75 of housing cover 50 could have a third textured surface 300 including a third pattern of elements 305, and/or rear portion 35 of blade platform 20 could have a fourth textured surface 400 including a fourth pattern of elements 405. As described in more detail below, first pattern of elements 105, second pattern of elements 205, third pattern of elements 305, and/or fourth pattern of elements 405 could comprises a first plurality of parallel grooves (see, e.g., FIGS. 3A-C, 4A-C, 8A-C, and 9A-C), a plurality of dimples (see, e.g., FIGS. 5A-C and 10A-C), or a combination of the first plurality of parallel grooves and a second plurality of parallel grooves that intersect the first plurality of parallel grooves (see, e.g., FIGS. 6A-C, 7A-C, 11A-C, and 12A-C).

Referring to FIGS. 3A-C and 8A-C, first pattern of elements 105 on front portion 70 of housing cover 50, second pattern of elements 205 on front portion 30 of blade platform 20, third pattern of elements 305 on rear portion 75 of housing cover 50, and/or fourth pattern of elements 405 on rear portion 35 of blade platform 20 can include a first plurality of parallel grooves 120A that extend longitudinally perpendicular to a front edge 60 (first pattern of elements 105 and second pattern of elements 205) or a rear edge 65 (third pattern of elements 305 and fourth pattern of elements 405) of housing cover 50. First plurality of parallel grooves 120A can be formed, for example, by laser ablation. In one example, the laser ablation could be performed by an ultrashort pulse laser set at a power setting of 8 μJ and a wavelength of 1030 nm. The beam diameter used could be approximately 50% of the depth of the grooves being formed.

First plurality of parallel grooves 120A can each have a depth 110 of 10 μm to 100 μm, preferably 40 μm to 60 μm, and a width 115 of 20 μm to 100 μm, preferably 40 μm to 60 μm, at top surface 55 of housing cover 50 or top surface 25 of blade platform 20, respectively. A length of each of first plurality of parallel grooves 120A, perpendicular to width 115, can extend between 1 mm and 8 mm, depending on the size of housing cover 50/blade platform 20. First plurality of parallel grooves 120A can be spaced apart by a distance 135 of 20 μm to 100 μm, preferably 40 μm to 80 μm.

Testing has shown that an aluminum plate having a plurality of parallel grooves (e.g., first plurality of parallel grooves 120A) laser ablated/etched into the surface provides a generally hydrophilic surface. In addition, an aluminum plate having a plurality of parallel grooves (e.g., first plurality of parallel grooves 120A) laser ablated/etched into the surface and having a length oriented perpendicular to the direction of travel over the skin has a lower coefficient of friction, on average, than an aluminum plate with no surface texturing with the surface dry, wetted with water, and wetted with a shaving aid solution. Therefore, providing a plurality of parallel grooves (e.g., first plurality of parallel grooves 120A) laser ablated/etched into the front portion and/or rear portion of the housing cover and/or blade platform will allow the shaving razor to glide over the skin of a user more smoothly and easily than a shaving razor with no textured surfaces.

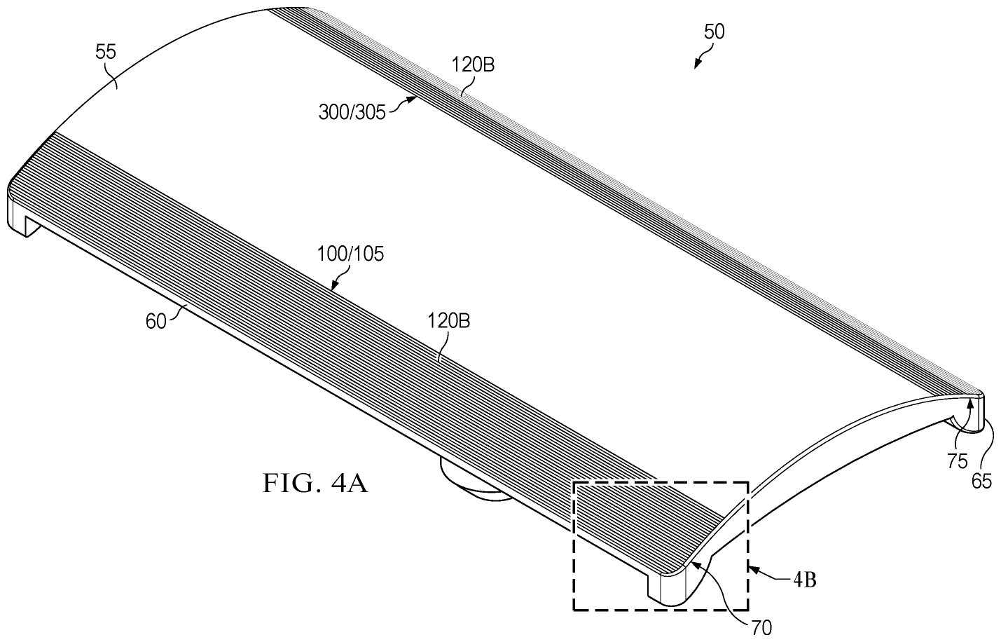

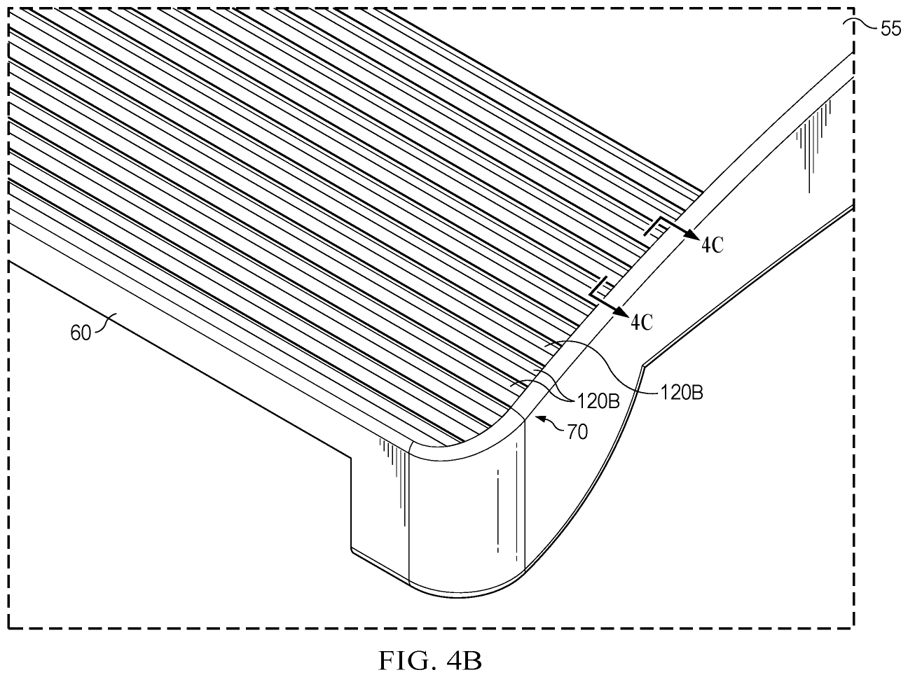

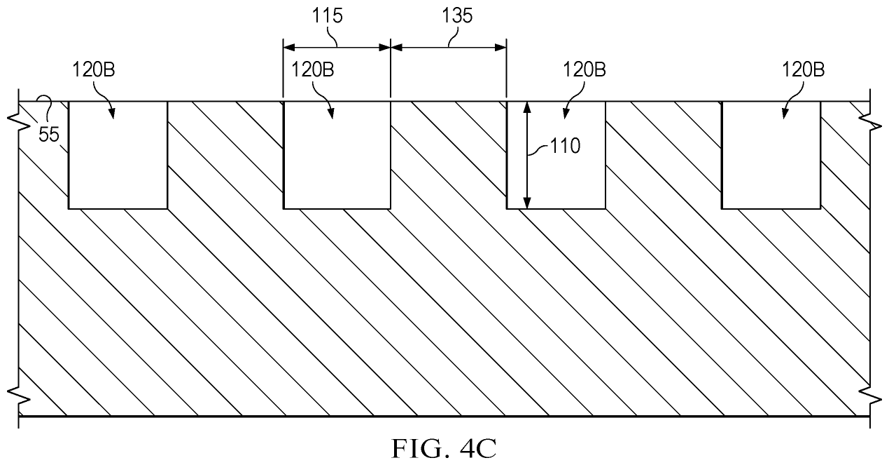

Referring to FIGS. 4A-C and 9A-C, first pattern of elements 105 on front portion 70 of housing cover 50, second pattern of elements 205 on front portion 30 of blade platform 20, third pattern of elements 305 on rear portion 75 of housing cover 50, and/or fourth pattern of elements 405 on rear portion 35 of blade platform 20 can include a first plurality of parallel grooves 120B that extend longitudinally parallel to front edge 60 (first pattern of elements 105 and second pattern of elements 205) or rear edge 65 (third pattern of elements 305 and fourth pattern of elements 405) of housing cover 50. First plurality of parallel grooves 120B can be formed, for example, by laser ablation.

First plurality of parallel grooves 120B can each have a depth 110 of 10 μm to 100 μm, preferably 40 μm to 60 μm, and a width 115 of 20 μm to 100 μm, preferably 40 μm to 60 μm, at top surface 55 of housing cover 50 or top surface 25 of blade platform 20, respectively. A length of each of first plurality of parallel grooves 120A, perpendicular to width 115, can extend between 1 mm and 40 mm, depending on the size of housing cover 50/blade platform 20. First plurality of parallel grooves 120A can be spaced apart by a distance 135 of 20 μm to 100 μm, preferably 40 μm to 80 μm.

Testing has shown that an aluminum plate having a plurality of parallel grooves (e.g., first plurality of parallel grooves 120B) laser ablated/etched into the surface provides a generally hydrophilic surface. In addition, an aluminum plate having a plurality of parallel grooves (e.g., first plurality of parallel grooves 120B) laser ablated/etched into the surface and having a length oriented perpendicular to the direction of travel over the skin has a lower coefficient of friction, on average, than an aluminum plate with no surface texturing with the surface dry, wetted with water, and wetted with a shaving aid solution. Therefore, providing a plurality of parallel grooves (e.g., first plurality of parallel grooves 120B) laser ablated/etched into the front portion and/or rear portion of a of the housing cover and/or blade platform will allow the shaving razor to glide over the skin of a user more smoothly and easily than a shaving razor with no textured surfaces.

Referring to FIGS. 5A-C and 10A-C, first pattern of elements 105 on front portion 70 of housing cover 50, second pattern of elements 205 on front portion 30 of blade platform 20, third pattern of elements 305 on rear portion 75 of housing cover 50, and/or fourth pattern of elements 405 on rear portion 35 of blade platform 20 can include a plurality of dimples 125. Plurality of dimples 125 can be formed, for example, by laser ablation.

Plurality of dimples 125 can each have a depth 110 of 10 μm to 100 μm, preferably 20 μm to 70 μm, and a width 115 of 20 μm to 100 μm, preferably 40 μm to 60 μm, at top surface 55 of housing cover 50 or top surface 25 of blade platform 20, respectively. Plurality of dimples 125 can be spaced apart by a distance 135 of 20 μm to 100 μm, preferably 40 μm to 80 μm, and can have an area measured at top surface 25/55 of 0.001 mm² to 0.008 mm². Each dimple 125 can be circular at top surface 25/55, or any other shape appropriate for a given application, and can have a density of 25 to 400 dimples per mm², and cover an area of 50 mm² to 300 mm².

Testing has shown that an aluminum plate having a plurality of dimples (e.g., plurality of dimples 125) laser ablated/etched into the surface provides a generally hydrophilic surface. In addition, an aluminum plate having a plurality of dimples (e.g., plurality of dimples 125) laser ablated/etched into the surface has a lower coefficient of friction, on average, than an aluminum plate with no surface texturing with the surface dry, wetted with water, and wetted with a shaving aid solution. Therefore, providing a plurality of dimples (e.g., plurality dimples 125) laser ablated/etched into the front portion and/or rear portion of a blade platform and/or housing cover of a shaving razor will allow the shaving razor to glide over the skin of a user more smoothly and easily than a shaving razor with no textured surfaces.

Referring to FIGS. 6A-C and 11A-C, first pattern of elements 105 on front portion 70 of housing cover 50, second pattern of elements 205 on front portion 30 of blade platform 20, third pattern of elements 305 on rear portion 75 of housing cover 50, and/or fourth pattern of elements 405 on rear portion 35 of blade platform 20 can include first plurality of parallel grooves 120B (or first plurality of parallel grooves 120A) and a second plurality of parallel grooves 130A that intersect first plurality of parallel grooves 120B and each have a length that extends at an angle of 90 degrees relative to the lengths of first plurality of parallel grooves 120B (forming a plurality of “rectangular columns”). First plurality of parallel grooves 120B and second plurality of parallel grooves 130A can be formed, for example, by laser ablation.

Second plurality of parallel grooves 130A can each have a depth 110 of 10 μm to 100 μm, preferably 40 μm to 60 μm, and a width 115 of 20 μm to 100 μm, preferably 40 μm to 60 μm, at top surface 55 of housing cover 50 or top surface 25 of blade platform 20, respectively. Second plurality of parallel grooves 130A can be spaced apart by a distance 135 of 20 μm to 100 μm, preferably 40 μm to 80 μm.

Testing has shown that an aluminum plate having a first plurality of parallel grooves (e.g., first plurality of parallel grooves 120B) and a second plurality of grooves (e.g., second plurality of parallel grooves 130A) laser ablated/etched into the surface perpendicular to each other to form a plurality of “rectangular columns” provides a generally hydrophobic surface. In addition, an aluminum plate having a first plurality of parallel grooves (e.g., first plurality of parallel grooves 120B) having a length oriented perpendicular to the direction of travel over the skin and a second plurality of parallel grooves (e.g., second plurality of parallel grooves 130A) having a length oriented parallel to the direction of travel over the skin laser ablated/etched into the surface to form a plurality of “rectangular columns” has a lower coefficient of friction, on average, than an aluminum plate with no surface texturing with the surface dry and wetted with a shaving aid solution. However, the surface with the “rectangular columns” did show a higher coefficient of friction, on average, than an aluminum plate with no surface texturing with the surface wetted with water. Therefore, providing a first plurality of parallel grooves (e.g., first plurality of parallel grooves 120B) having a length oriented perpendicular to the direction of travel over the skin and a second plurality of parallel grooves (e.g., second plurality of parallel grooves 130A) having a length oriented parallel to the direction of travel over the skin laser ablated/etched into the front portion and/or rear portion of the housing cover and/or blade platform of a shaving razor to form a plurality of “rectangular columns” will allow the shaving razor to glide over the skin of a user more smoothly and easily than a shaving razor with no textured surfaces in some circumstances.

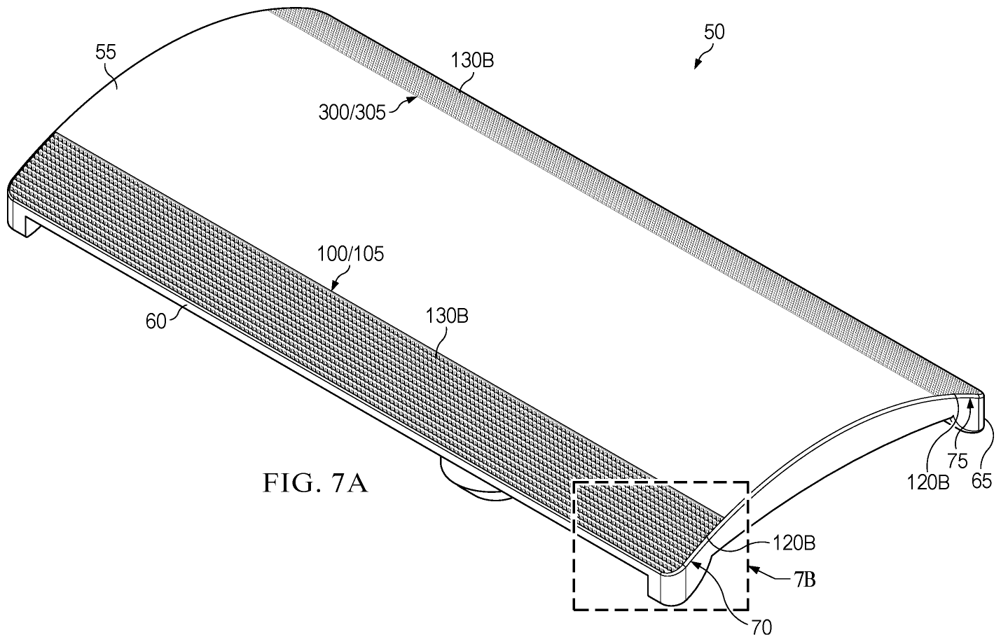

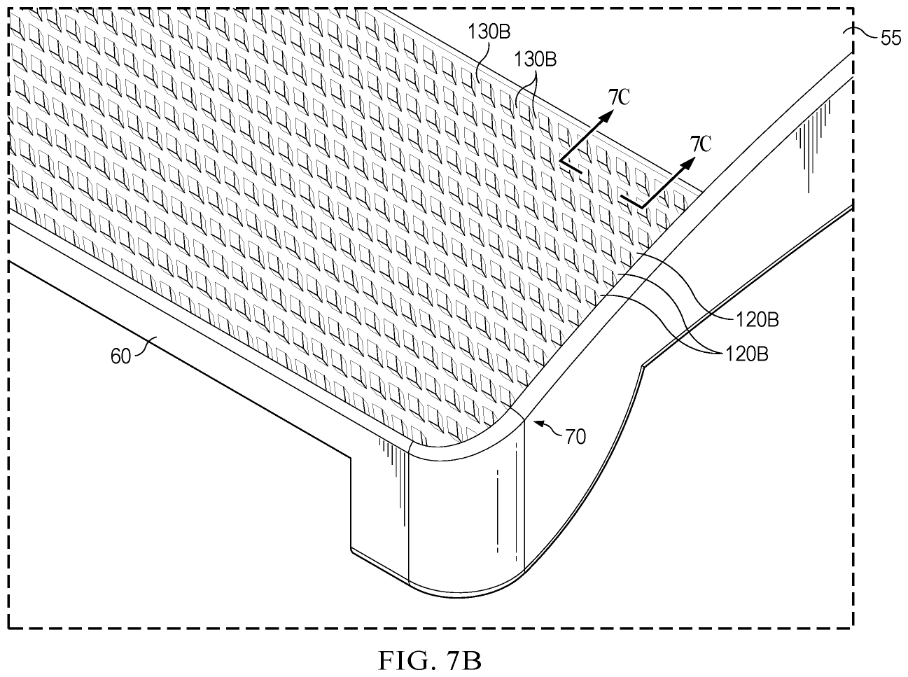

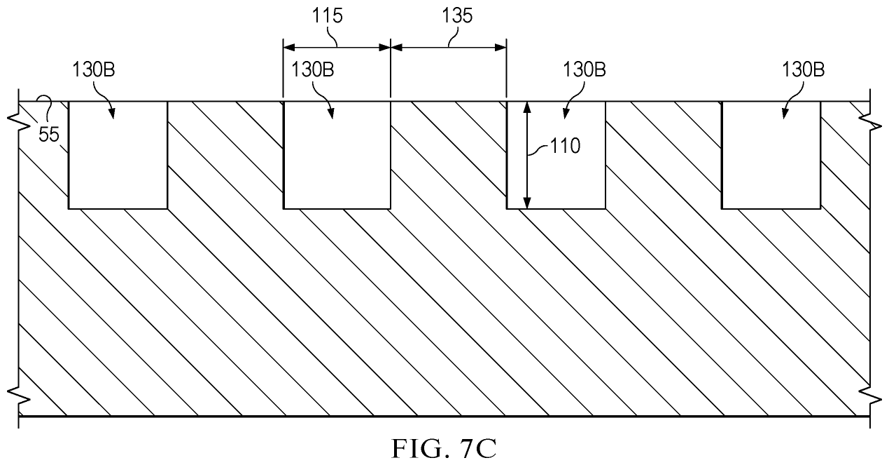

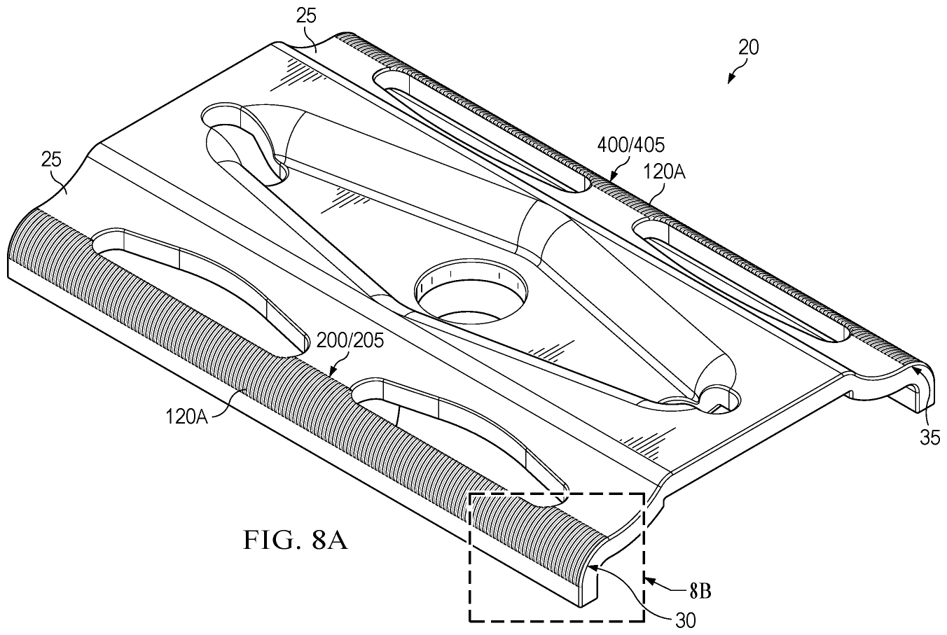

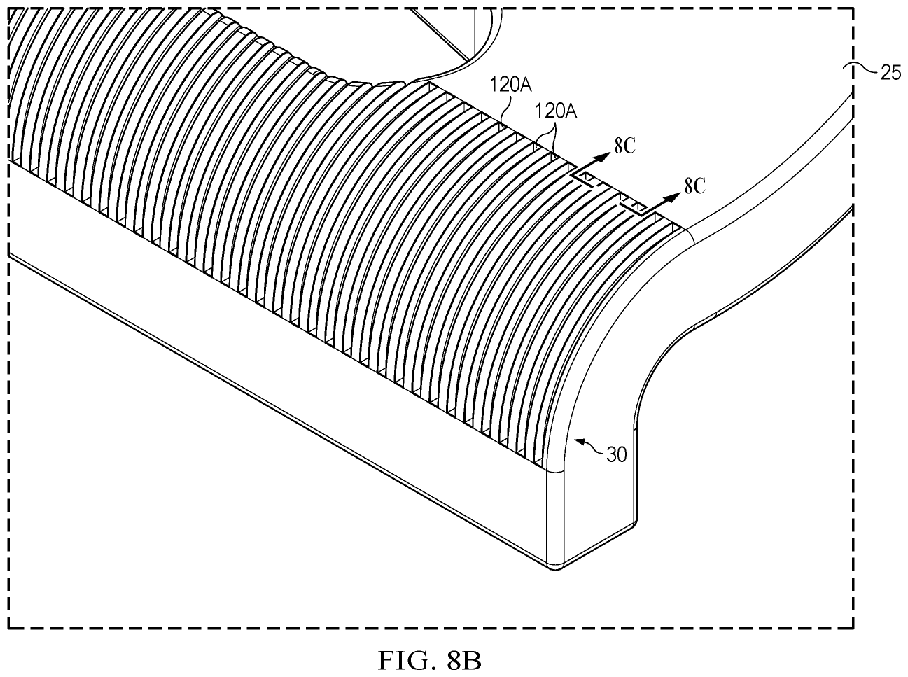

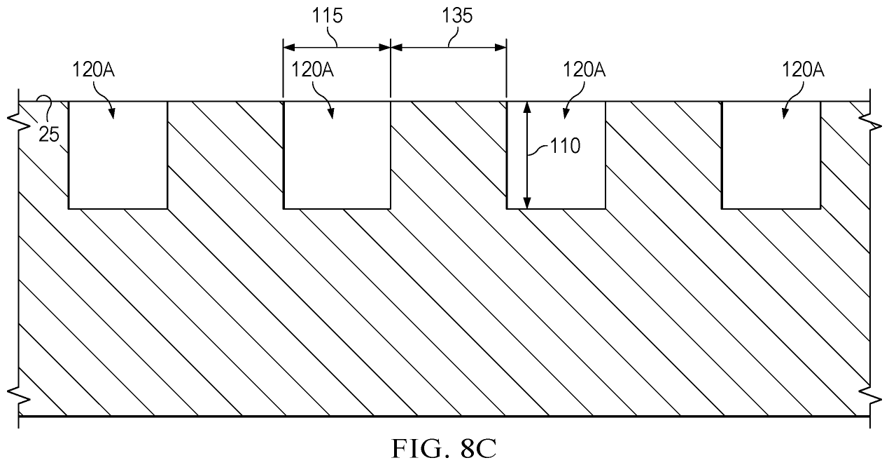

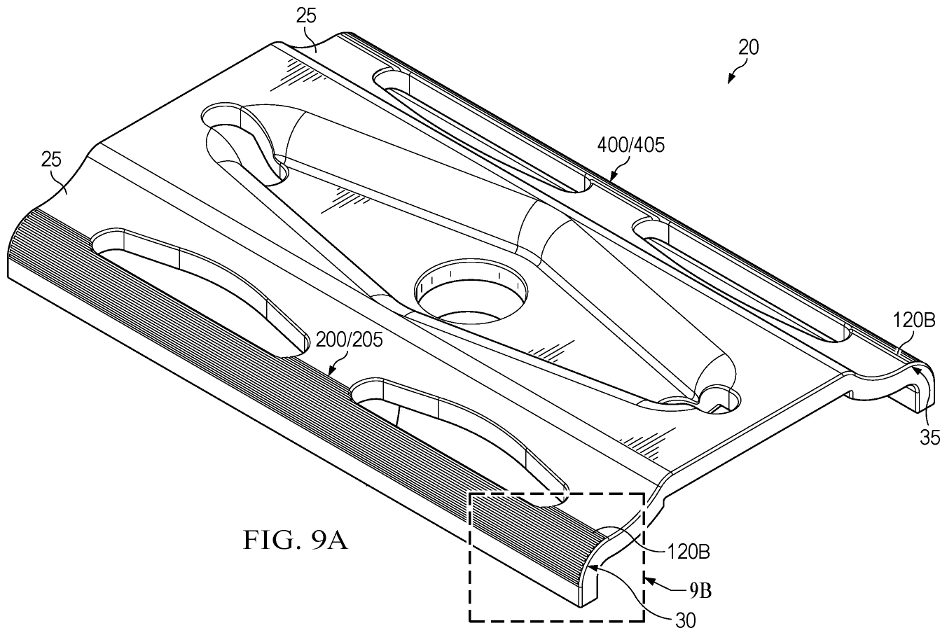

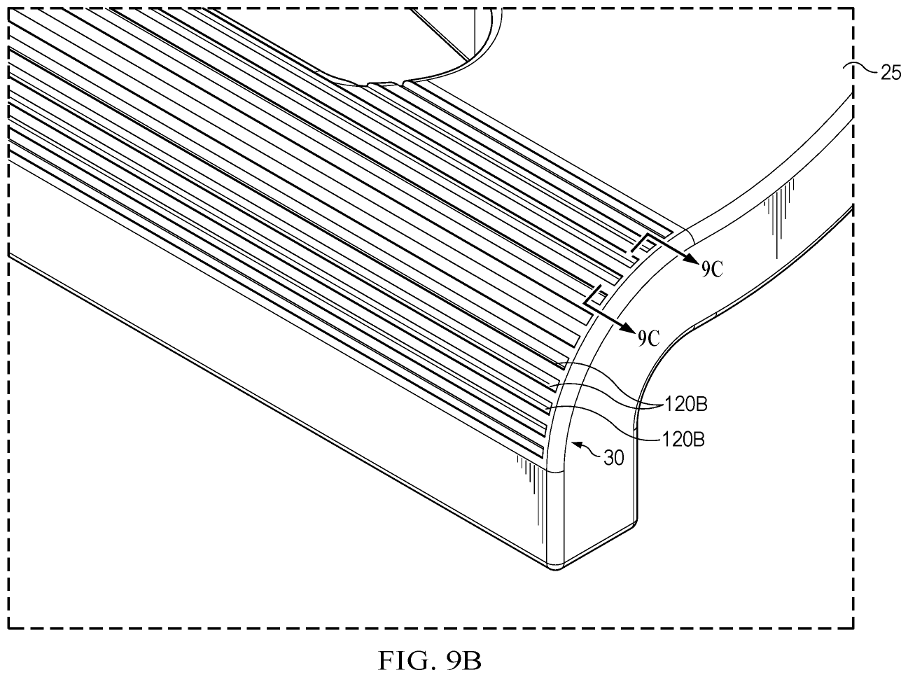

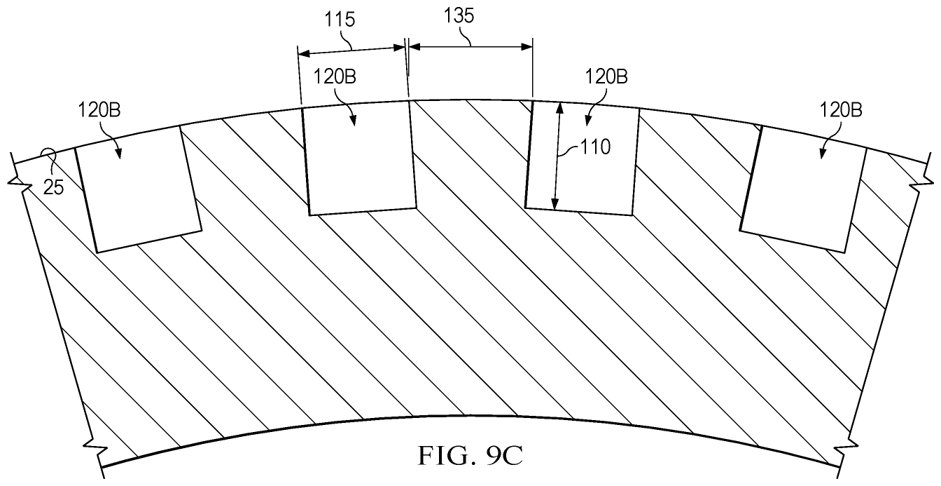

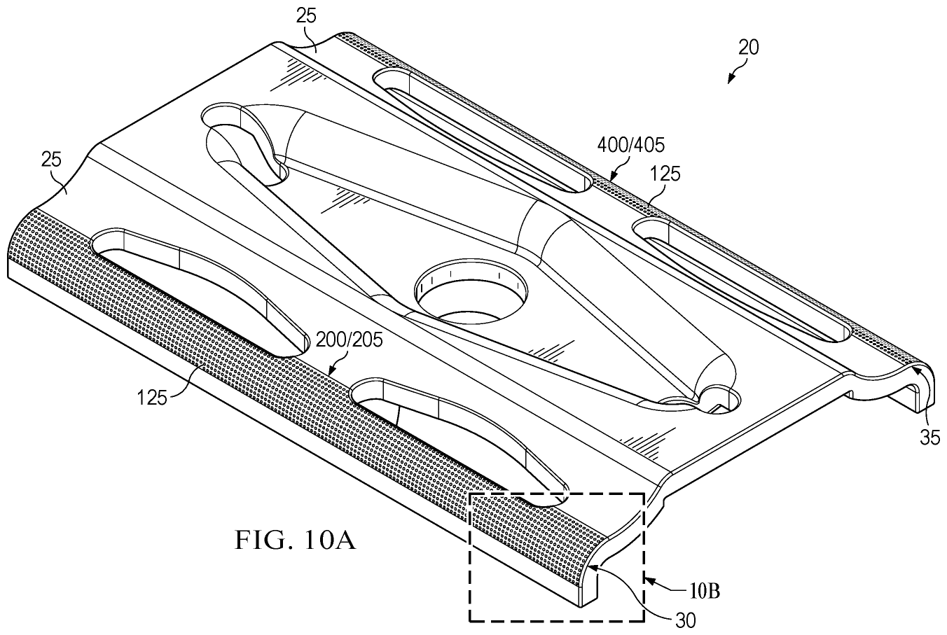

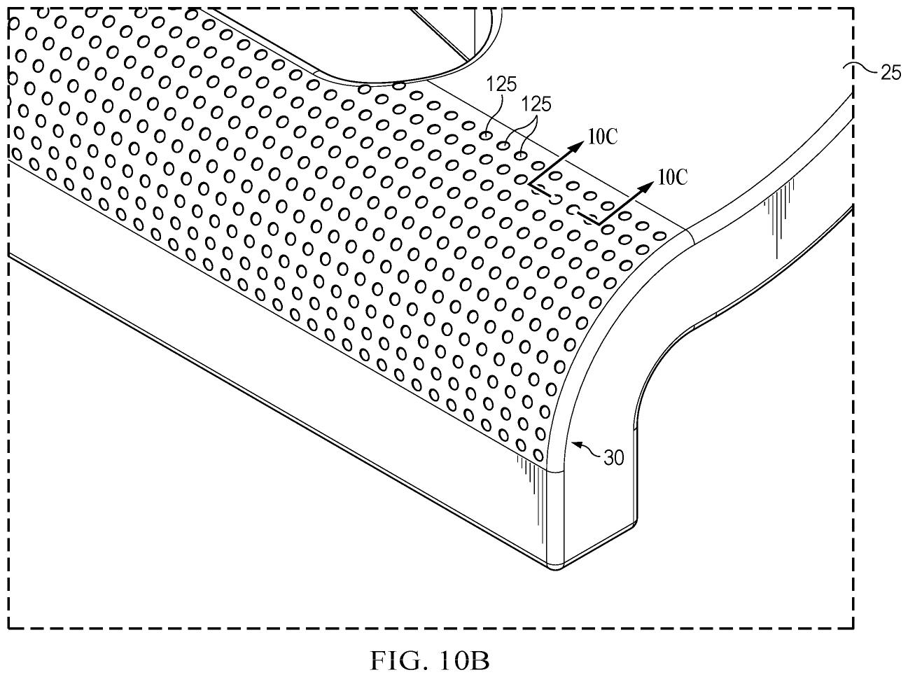

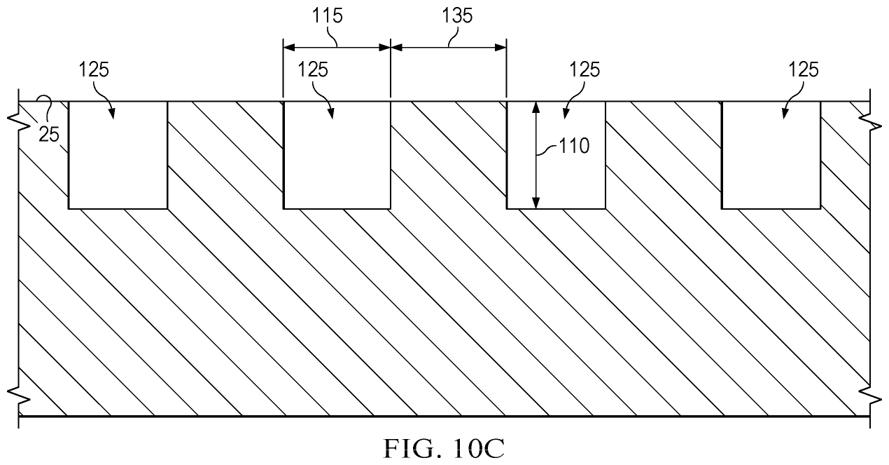

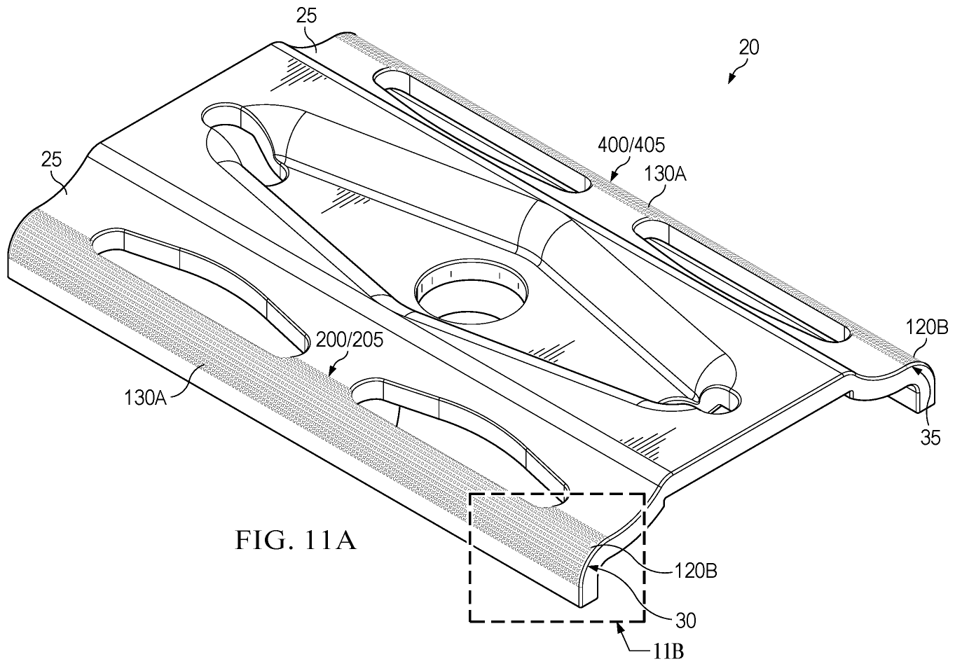

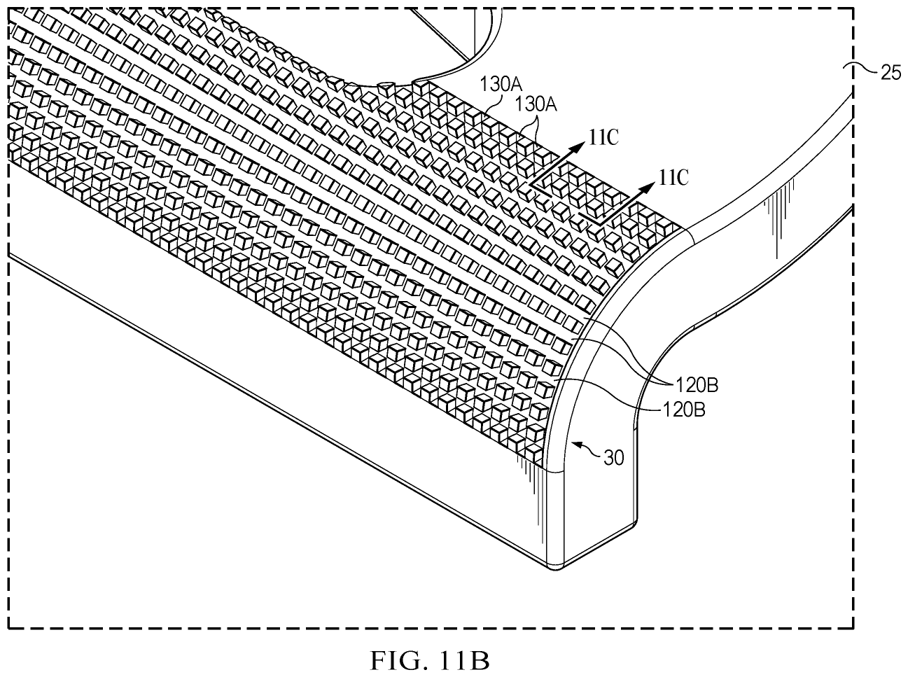

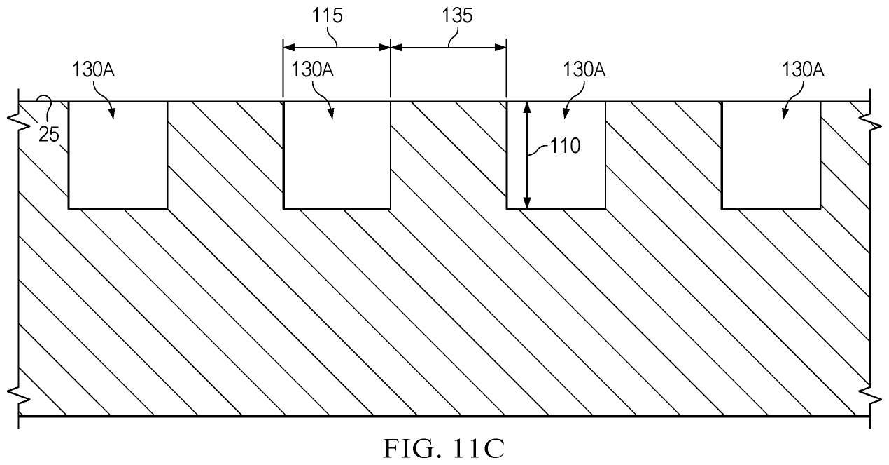

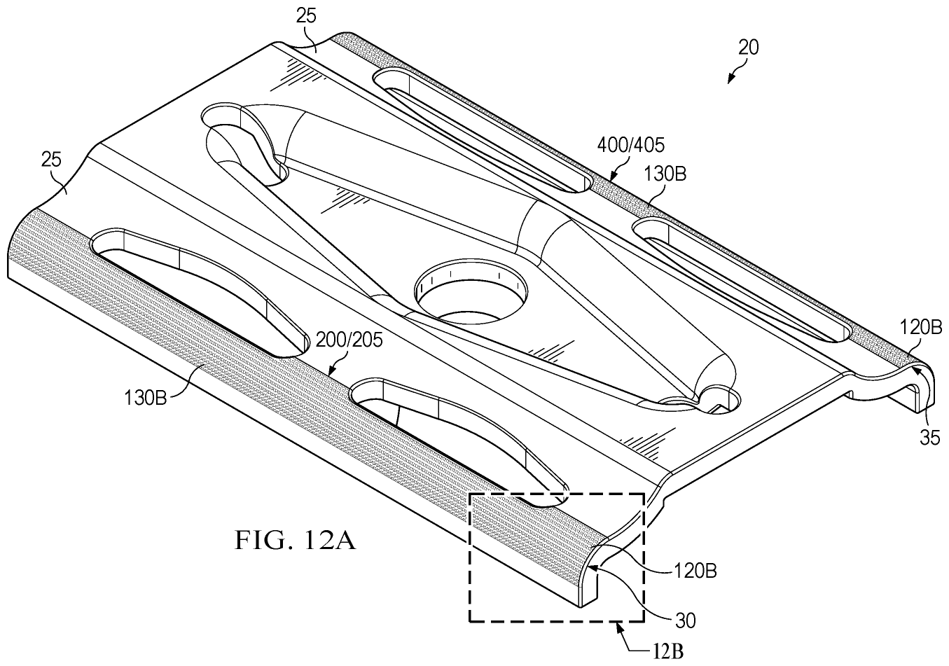

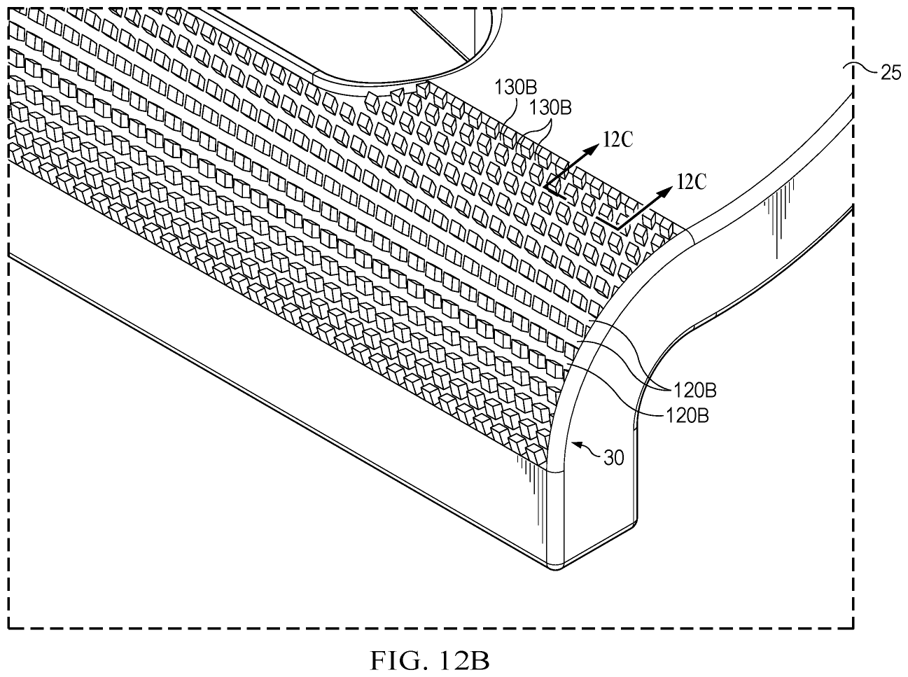

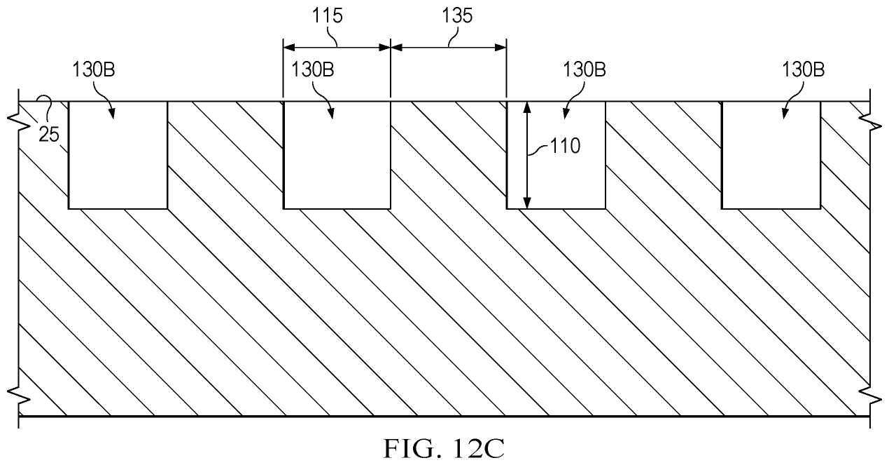

Referring to FIGS. 7A-C and 12A-C, first pattern of elements 105 on front portion 70 of housing cover 50, second pattern of elements 205 on front portion 30 of blade platform 20, third pattern of elements 305 on rear portion 75 of housing cover 50, and/or fourth pattern of elements 405 on rear portion 35 of blade platform 20 can include first plurality of parallel grooves 120B (or first plurality of parallel grooves 120A) and a second plurality of parallel grooves 130B that intersect first plurality of parallel grooves 120B and each have a length that extends at an angle of 45 to 75 degrees, in one embodiment 60 degrees, relative to the lengths of first plurality of parallel grooves 120B (forming a plurality of “angled columns”). First plurality of parallel grooves 120B and second plurality of parallel grooves 130B can be formed, for example, by laser ablation.

Second plurality of parallel grooves 130B can each have a depth 110 of 10 μm to 100 μm, preferably 40 μm to 60 μm, and a width 115 of 20 μm to 100 μm, preferably 40 μm to 60 μm, at top surface 55 of housing cover 50 or top surface 25 of blade platform 20, respectively. Second plurality of parallel grooves 130B can be spaced apart by a distance 135 of 20 μm to 100 μm, preferably 40 μm to 80 μm.

Testing has shown that an aluminum plate having a first plurality of parallel grooves (e.g., first plurality of parallel grooves 120B) and a second plurality of parallel grooves (e.g., second plurality of parallel grooves 130B) laser ablated/etched into the surface at a 60 degree angle to each other to form a plurality of “angled columns” provides a generally hydrophilic surface. In addition, an aluminum plate having a first plurality of parallel grooves (e.g., first plurality of parallel grooves 120B) having a length oriented perpendicular to the direction of travel over the skin and a second plurality of parallel grooves (e.g., second plurality of parallel grooves 130B) having a length oriented at a 60 degree angle to the length of the first plurality of grooves laser ablated/etched into the surface to form a plurality of “angled columns” has a lower coefficient of friction, on average, than an aluminum plate with no surface texturing with the surface dry. However, the surface with the “angled columns” did show a higher coefficient of friction, on average, than an aluminum plate with no surface texturing with the surface wetted with water and wetted with a shaving aid solution. Therefore, providing a first plurality of parallel grooves (e.g., first plurality of parallel grooves 120B) having a length oriented perpendicular to the direction of travel over the skin and a second plurality of parallel grooves (e.g., second plurality of parallel grooves 130B) having a length oriented at a 60 degree angle to the length of the first plurality of grooves laser ablated/etched into the front portion and/or rear portion of the housing cover and/or blade platform of a shaving razor to form a plurality of “angled columns” will allow the shaving razor to grab and pull the skin tight better than a shaving razor with no textured surfaces when the shaving razor is wetted with water or wetted with a shaving aid solution.

As noted above, first pattern of elements 105 on front portion 70 of housing cover 50, second pattern of elements 205 on front portion 30 of blade platform 20, third pattern of elements 305 on rear portion 75 of housing cover 50, and/or fourth pattern of elements 405 on rear portion 35 of blade platform 20 can any combination of first plurality of parallel grooves 120A, 120B, plurality of dimples 125, and/or first plurality of parallel grooves 120A, 120B and second plurality of grooves 130A, 130B, depending on the particular application. For example, blade platform 20 can have first and second plurality of parallel grooves 120B, 130B formed on front portion 30 and rear portion 35 to provide grip and pull the skin before it reaches shaving blades 40 and housing cover 50 can have no grooves, first plurality of parallel grooves 120A, 120B, dimples 125, or first and second plurality of parallel grooves 120B, 130A on front portion 70 and rear portion 75 to allow housing cover 50 to slide over the skin after engaged by shaving blades 40. Alternatively, to allow shaving razor 10 to slide over the skin without providing extra gripping of the skin, front portion 30 and rear portion 35 of blade platform 20 and front portion 70 and rear portion 75 of housing cover 50 can have first plurality of parallel grooves 120A, 120B, dimples 125, or first and second plurality of parallel grooves 120B, 130A.

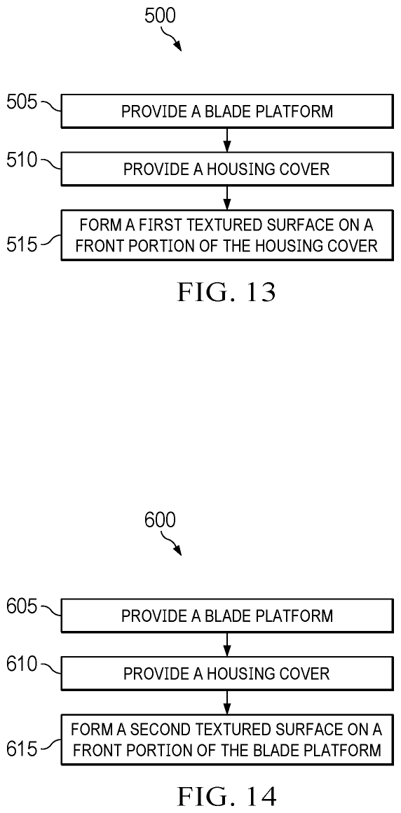

Referring to FIG. 13, an example method 500 for making a shaving razor (e.g., shaving razor 10) is illustrated.

At Step 505 of method 500, a blade platform (e.g., blade platform 20) that is configured to receive one or more shaving blades (e.g., shaving blade 40) is provided.

At Step 510, a housing cover (e.g., housing cover 50) that is configured to be removably secured to the blade platform is provided.

At Step 515, a first textured surface (e.g., first textured surface 100) including a first pattern of elements (e.g., first pattern of elements 105) is formed on a front portion (e.g., front portion 70) of the housing cover. The first pattern of elements has a depth of 10 μm to 100 μm, preferably 40 μm to 60 μm, and a width of 20 μm to 100 μm, preferably 40 μm to 60 μm, at a top surface of the housing cover. The laser ablation could be performed by an ultrashort pulse laser set at a power setting of 8 μJ and a wavelength of 1030 nm. The beam diameter used could be approximately 50% of the depth of the grooves being formed.

As discussed above, the first pattern of elements could include a first plurality of parallel grooves (e.g., first plurality of parallel grooves 120A, 120B) that extend parallel or perpendicular to a front edge (e.g., front edge 60) of the housing cover, a plurality of dimples (e.g., plurality of dimples 125), or the first plurality of parallel grooves and a second plurality of parallel grooves (e.g., second plurality of parallel grooves 130A, 130B) that intersect the first plurality of parallel grooves.

In addition, if desired, a second textured surface (e.g., second textured surface 200) including a second pattern of elements (e.g., second pattern of elements 205) can be formed on a front portion (e.g., front portion 30) of the blade platform (e.g., blade platform 20) by laser ablating the front portion of the blade platform. The second pattern of elements can have a depth of 10 μm to 100 μm and a width of 20 μm to 100 μm at a top surface of the blade platform.

As discussed above, the second pattern of elements could include a first plurality of parallel grooves (e.g., first plurality of parallel grooves 120A, 120B) that extend parallel or perpendicular to a front edge (e.g., front edge 60) of the housing cover, a plurality of dimples (e.g., plurality of dimples 125), or the first plurality of parallel grooves and a second plurality of parallel grooves (e.g., second plurality of parallel grooves 130A, 130B) that intersect the first plurality of parallel grooves.

Furthermore, if desired, forming a third textured surface (e.g., third textured surface 300) including a third pattern of elements (e.g., third pattern of elements 305) can be formed on a rear portion (e.g., rear portion 75) of the housing cover by laser ablating the rear portion of the housing cover. The third pattern of elements can have a depth of 10 μm to 100 μm and a width of 20 μm to 100 μm at a top surface of housing cover.

As discussed above, the third pattern of elements could include a first plurality of parallel grooves (e.g., first plurality of parallel grooves 120A, 120B) that extend parallel or perpendicular to a rear edge (e.g., rear edge 65) of the housing cover, a plurality of dimples (e.g., plurality of dimples 125), or the first plurality of parallel grooves and a second plurality of parallel grooves (e.g., second plurality of parallel grooves 130A, 130B) that intersect the first plurality of parallel grooves.

Referring to FIG. 14, an example method 600 for making a shaving razor (e.g., shaving razor 10) is illustrated.

At Step 605 of method 600, a blade platform (e.g., blade platform 20) that is configured to receive one or more shaving blades (e.g., shaving blade 40) is provided.

At Step 610, a housing cover (e.g., housing cover 50) that is configured to be removably secured to the blade platform is provided.

At Step 615, a second textured surface (e.g., second textured surface 200) including a second pattern of elements (e.g., second pattern of elements 205) is formed on a front portion (e.g., front portion 30) of the blade platform. The second pattern of elements has a depth of 10 μm to 100 μm, preferably 40 μm to 60 μm, and a width of 20 μm to 100 μm, preferably 40 μm to 60 μm, at a top surface of the blade platform. The laser ablation could be performed by an ultrashort pulse laser set at a power setting of 8 μJ and a wavelength of 1030 nm. The beam diameter used could be approximately 50% of the depth of the grooves being formed.

As discussed above, the second pattern of elements could include a first plurality of parallel grooves (e.g., first plurality of parallel grooves 120A, 120B) that extend parallel or perpendicular to a front edge (e.g., front edge 60) of the housing cover, a plurality of dimples (e.g., plurality of dimples 125), or the first plurality of parallel grooves and a second plurality of parallel grooves (e.g., second plurality of parallel grooves 130A, 130B) that intersect the first plurality of parallel grooves.

In addition, if desired, a fourth textured surface (e.g., fourth textured surface 400) including a fourth pattern of elements (e.g., fourth pattern of elements 405) could be formed on a rear portion (e.g., rear portion 35) of the blade platform by laser ablating the rear portion of the blade platform. The fourth pattern of elements can have a depth of 10 μm to 100 μm and a width of 20 μm to 100 μm at a top surface of the blade platform.

As discussed above, the fourth pattern of elements could include a first plurality of parallel grooves (e.g., first plurality of parallel grooves 120A, 120B) that extend parallel or perpendicular to a rear edge (e.g., rear edge 65) of the housing cover, a plurality of dimples (e.g., plurality of dimples 125), or the first plurality of parallel grooves and a second plurality of parallel grooves (e.g., second plurality of parallel grooves 130A, 130B) that intersect the first plurality of parallel grooves.

Furthermore, if desired, a first textured surface (e.g., first textured surface 100) including a first pattern of elements (e.g., first pattern of elements 105) can be formed on a front portion (e.g., front portion 70) of the housing cover by laser ablating the front portion of the housing cover and a third textured surface (e.g., third textured surface 300) including a third pattern of elements (e.g., third pattern of elements 305) can be formed on a rear portion (e.g., rear portion 75) of the housing cover by laser ablating the rear portion of the housing cover. The first pattern of elements and the third pattern of elements can have a depth of 10 μm to 100 μm and a width of 20 μm to 100 μm at a top surface of the housing cover.

As discussed above, the first pattern of elements could include a first plurality of parallel grooves (e.g., first plurality of parallel grooves 120A, 120B) that extend parallel or perpendicular to a front edge (e.g., front edge 60) of the housing cover, a plurality of dimples (e.g., plurality of dimples 125), or the first plurality of parallel grooves and a second plurality of parallel grooves (e.g., second plurality of parallel grooves 130A, 130B) that intersect the first plurality of parallel grooves. Similarly, the third pattern of elements could include a first plurality of parallel grooves (e.g., first plurality of parallel grooves 120A, 120B) that extend parallel or perpendicular to a rear edge (e.g., rear edge 65) of the housing cover, a plurality of dimples (e.g., plurality of dimples 125), or the first plurality of parallel grooves and a second plurality of parallel grooves (e.g., second plurality of parallel grooves 130A, 130B) that intersect the first plurality of parallel grooves.

The dimensions and values disclosed herein are not to be understood as being strictly limited to the exact numerical values recited. The dimensions should not be held to an impossibly high standard of metaphysical identity that does not allow for discrepancies due to typical manufacturing and measuring tolerances. Therefore, the term “about” should be interpreted as being within typical manufacturing and measuring tolerances.

To the extent that any meaning or definition of a term in this document conflicts with any meaning or definition of the same term in another document, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving razor, comprising:
a blade platform configured to support one or more shaving blades; and
a housing cover removably secured on top of the blade platform; wherein
the housing cover has a front portion with a first textured surface including a first pattern of elements with a depth of 10 μm to 100 μm and a width of 20 μm to 100 μm at a top surface of the housing cover.

2. The shaving razor of claim 1, wherein the first pattern of elements comprises one of a first plurality of parallel grooves, a plurality of dimples, or the first plurality of parallel grooves and a second plurality of parallel grooves intersecting the first plurality of parallel grooves.

3. The shaving razor of claim 1, wherein the first pattern of elements comprises a first plurality of parallel grooves that extend longitudinally perpendicular to a front edge of the housing cover.

4. The shaving razor of claim 1, wherein the blade platform has a front portion with a second textured surface including a second pattern of elements with a depth of 10 μm to 100 μm and a width of 20 μm to 100 μm at a top surface of the blade platform.

5. The shaving razor of claim 4, wherein the second pattern of elements comprises one of a first plurality of parallel grooves, a plurality of dimples, or the first plurality of parallel grooves and a second plurality of parallel grooves intersecting the first plurality of parallel grooves.

6. The shaving razor of claim 4, wherein the second pattern of elements comprises a first plurality of parallel grooves that extend longitudinally either parallel or perpendicular to a front edge of the housing cover and a second plurality of parallel grooves intersecting the first plurality of parallel grooves and extending longitudinally at an angle of 45 to 75 degrees relative to the first plurality of parallel grooves.

7. The shaving razor of claim 1, wherein the housing cover has a rear portion with a third textured surface including a third pattern of elements with a depth of 10 μm to 100 μm and a width of 20 μm to 100 μm at a top surface of the housing cover.

8. The shaving razor of claim 7, wherein the first pattern of elements and the third pattern of elements comprise one of a first plurality of parallel grooves, a plurality of dimples, or the first plurality of parallel grooves and a second plurality of parallel grooves intersecting the first plurality of parallel grooves.

9. The shaving razor of claim 7, wherein the third pattern of elements comprises a first plurality of parallel grooves that extend longitudinally perpendicular to a rear edge of the housing cover.

10. A shaving razor, comprising:
a blade platform configured to support one or more shaving blades; and
a housing cover removably secured on top of the blade platform; wherein
the blade platform has a front portion with a second textured surface including a second pattern of elements with a depth of 10 μm to 100 μm and a width of 20 μm to 100 μm at a top surface of the blade platform.

11. The shaving razor of claim 10, wherein the second pattern of elements comprises one of a first plurality of parallel grooves, a plurality of dimples, or the first plurality of parallel grooves and a second plurality of parallel grooves intersecting the first plurality of parallel grooves.

12. The shaving razor of claim 10, wherein the second pattern of elements comprises a first plurality of parallel grooves that extend longitudinally either parallel to or perpendicular to a front edge of the housing cover and a second plurality of parallel grooves that intersect the first plurality of parallel grooves and extend longitudinally at an angle of 45 to 75 degrees relative to the first plurality of parallel grooves.

13. The shaving razor of claim 11, wherein the first plurality of parallel grooves, the plurality of dimples, or the second plurality of parallel grooves are spaced apart by a distance of 20 μm to 100 μm.

14. The shaving razor of claim 10, wherein the blade platform has a rear portion with a fourth textured surface including a fourth pattern of elements with a depth of 10 μm to 100 μm and a width of 20 μm to 100 μm at a top surface of the blade platform.

15. The shaving razor of claim 14, wherein the second pattern of elements and the fourth pattern of elements comprise one of a first plurality of parallel grooves, a plurality of dimples, or the first plurality of parallel grooves and a second plurality of parallel grooves intersecting the first plurality of parallel grooves.

16. The shaving razor of claim 14, wherein the fourth pattern of elements comprises a first plurality of parallel grooves that extend longitudinally either parallel to or perpendicular to a rear edge of the housing cover and a second plurality of parallel grooves that intersect the first plurality of parallel grooves and extend longitudinally at an angle of 45 to 75 degrees relative to the first plurality of parallel grooves.

17. The shaving razor of claim 15, wherein the first plurality of parallel grooves, the plurality of dimples, or the second plurality of parallel grooves are spaced apart by a distance of 20 μm to 100 μm.

18. The shaving razor of claim 14, wherein:
the housing cover has a front portion with a first textured surface including a first pattern of elements with a depth of 10 μm to 100 μm and a width of 20 μm to 100 μm at a top surface of the housing cover; and
the housing cover has a rear portion with a third textured surface including a third pattern of elements with a depth of 10 μm to 100 μm and a width of 20 μm to 100 μm at the top surface of the housing cover.

19. The shaving razor of claim 18, wherein the first pattern of elements and the third pattern of elements each comprise one of a first plurality of parallel grooves, a plurality of dimples, or the first plurality of parallel grooves and a second plurality of parallel grooves intersecting the first plurality of parallel grooves.

20. The shaving razor of claim 18, wherein the first pattern of elements and the third pattern of elements each comprise a first plurality of parallel grooves, wherein the first plurality of parallel grooves of the first pattern of elements extend longitudinally perpendicular to a front edge of the housing cover and the first plurality of parallel grooves of the third pattern of elements extend longitudinally perpendicular to a rear edge of the housing cover.
